(19) United States
(12) Patent Application Publication
(10) Pub. No.: US 2020/0299592 A1
(43) Pub. Date: Sep. 24, 2020

(54) ELECTRO-KINETIC SEPARATION OF SALT AND SOLID FINES FROM CRUDE OIL

(71) Applicant: ExxonMobil Research and Engineering Company, Annandale, NJ (US)

(72) Inventors: Bhupender S. Minhas, Bridgewater, NJ (US); Ivy D. Johnson, Lawrenceville, NJ (US); Jessica Wittmann, Easton, PA (US); Jessica E. Gil, Houston, TX (US); Magaly C. Barroeta, Tomball, TX (US); Jason M. McMullan, Nazareth, PA (US); Sarah E. Feicht, Raritan, NJ (US); F. Pierce Hubbard, JR., Flemington, NJ (US); Won M. Kim, Philadelphia, PA (US)

(21) Appl. No.: 16/808,716

(22) Filed: Mar. 4, 2020

Related U.S. Application Data
(60) Provisional application No. 62/820,448, filed on Mar. 19, 2019.

(51) Int. Cl. C10G 32/02; C10G 53/02; B03C 5/00; B03C 5/02

(52) U.S. Cl. CPC C10G 32/02; C10G 53/02; C10G 2300/201; B03C 5/024; C10G 2300/1033; B03C 5/005

(57) ABSTRACT

A method includes introducing a crude oil process stream into an electro-kinetic separator (EKS), passing the crude oil process stream through an electric field generated by the EKS, and removing at least a portion of salt and solid particles from the crude oil process stream as the crude oil process stream passes through the electric field. A product stream is discharged from the EKS with reduced salt and solid particle count as compared to the crude oil process stream.

### CROSS REFERENCE TO RELATED APPLICATIONS

This application claims priority to U.S. Provisional Application Ser. No. 62/820,448 filed Mar. 19, 2019 which is herein incorporated by reference in its entirety.

### BACKGROUND

Crude oil normally contains impurities like water, salts in solution, and solid particulate matter or “fines.” Impurities can corrode and build up solid deposits in refinery units, to and thus should be removed before the crude oil is refined.

Crude oil impurities are commonly removed by “desalting,” in which the crude oil is mixed with water and a suitable demulsifying agent to form a water-in-oil emulsion. The emulsion provides intimate contact between the oil and the water so that the salts and solid particles pass into solution in the water. The emulsion is then subjected to a high voltage electrostatic field inside a closed separator vessel, often referred to as a “settler.” The electrostatic field helps coalesce and break the emulsion into an oil phase and a water phase. The oil phase rises to the top of the settler and forms an upper layer that is continuously drawn off. The water phase (commonly called “brine”) sinks to the bottom of the settler from where it is also continuously removed. Conventional desalting processes are capable of removing 50-65% of the solid fines from the crude oil, and the generated brine is subsequently treated or disposed of per environmental regulations.

With the availability of higher solid content crude oil or “tight” crude, solid fines removal via electrostatic desalting is becoming progressively more difficult. Moreover, future expected environmental regulations and constraints on water usage and disposal in desalting operations may make electrostatic desalting processes more complex and costly. Consequently, it is expected that electrostatic desalting processes will be less effective in removing fines for reliable and smoother downstream operations.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, without departing from the scope of this disclosure.

FIG. 1 is a schematic diagram of an example system for removing salt and solid particles from a hydrocarbon stream, according to one or more embodiments.

FIG. 2A is a schematic diagram of one example of the electro-kinetic separator of FIG. 1, according to one or more embodiments.

FIG. 2B is a cross-sectional end view of one example of the electro-kinetic separator media of FIG. 2A, according to one or more embodiments.

FIG. 3 is a schematic diagram of another system for removing salt and solid particles from the hydrocarbon stream of FIG. 1 and further including cleaning and regeneration capabilities, according to one or more embodiments.

FIG. 4 is a schematic of particle motion in a linear channel under the influence of an electric field.

FIG. 5 is a plot depicting solids concentrations of four crudes compared against the predictive model.

### DETAILED DESCRIPTION

This present disclosure is related to hydrocarbon separation processes and, more particularly, to waterless electro-kinetic separation processes for removing salts and solid particles from crude oil.

Embodiments disclosed herein describe systems and methods to reduce and/or remove salt and solid fines from crude oil without the use of water. More specifically, the embodiments described herein incorporate an electro-kinetic separation process, which is an environmentally friendly process for salt and solid fines removal without requiring the addition of water, and thus, does not generate brine that must be properly disposed of. The electro-kinetic separation processes described herein can be used as standalone processes or in combination with conventional desalting or filtering processes for crude oil, especially heavier crudes that include more contaminants such as fines and hydraulic fracturing contaminants. Advantages of the presently described systems and methods include waterless recovery, an environmentally friendly process, and more efficient removal of salt and fines as compared to conventional desalting processes.

Electro-kinetic separation can be used to effectively reduce solid (inorganic) particles, even solid particles with exceptionally small size, from a crude oil process stream with or without the need of a separate mechanical or electro-mechanical filtration aid. The filtration media of the electro-kinetic separators may become laden with collected solid particles and can be conveniently regenerated in-situ or ex-situ to reclaim utilized particle-abatement capacity of the electro-kinetic separator. In one aspect, the principles of the present disclosure describe a process for treating a crude oil process stream by removing at least a portion of the solid particles by passing the process stream through at least one electro-kinetic separator. In another aspect, the principles of the present disclosure describe a process for treating a hydrocarbon stream comprising a hydrocarbon and solid particles, the process comprising removing at least a portion of the solid particles from the process stream by passing the process stream through at least one electro-kinetic separator.

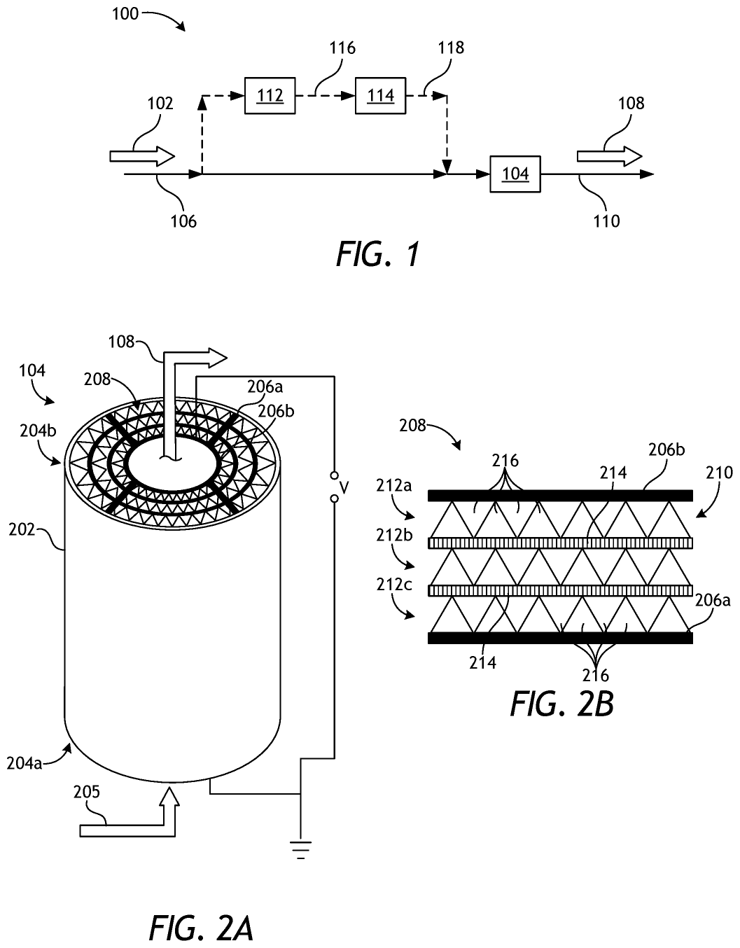

FIG. 1 is a schematic diagram of an example system 100 for removing salt and solid particles from a hydrocarbon stream 102, according to one or more embodiments. In contrast to conventional desalting systems that require the introduction of water into the process stream, the system 100 includes an electro-kinetic separator (“EKS”) 104 that removes salts and solid particles from the hydrocarbon stream 102 without the aid of water. Electro-kinetic separation refers to a filtration process that captures solid particles entrained in a liquid-containing fluid stream (e.g., the hydrocarbon stream 102) according to electrostatic principles and produces a product stream with reduced salts and solid particle counts.

The hydrocarbon stream 102 may alternately be referred to herein as a “process stream.” In some applications, the hydrocarbon stream 102 may comprise virgin crude oil originating from a subterranean hydrocarbon reservoir, or its products. In at least one embodiment, the hydrocarbon stream 102 may comprise a portion of crude oil remaining after the removal of distillates or the like. For example, the hydrocarbon stream 102 may comprise atmospheric tower bottoms, vacuum tower bottoms, or similar residuum products found in the refining of crude oil. The principles of the present disclosure, however, are equally applicable to treating other types of hydrocarbon process streams such as, but not limited to, or any combination thereof.

The hydrocarbon stream 102 may be laden with or otherwise have entrained therein impurities, such as salt and solid particles. Example salts that may be included in the hydrocarbon stream 102 include, but are not limited to, sodium chloride, metal sulfides, magnesium and calcium chlorides, other metal salts commonly originating from subterranean hydrocarbon-bearing formations, or any combination thereof.

The solid particles entrained in the hydrocarbon stream 102, alternately be referred to as “particulates” or “fines,” may have an average particle size of from about 1 to 1000 micrometers (μm) measured by using ASTM D7596-14. In at least one embodiment, the solid particles exhibit an average particle size ranging from sub-micron to about 25 μm. Example solid particles that may be included in the hydrocarbon stream 102 include, but are not limited to, sand, proppant, rock, salt, a corrosion product (e.g., iron oxide, iron sulfide, etc.), or any combination thereof.

The hydrocarbon stream 102 may include solid particles in a concentration as measured by ASTM D4807-5 in a range from p1 ppmw (parts per million by weight) to p2 ppmw, based on the total weight of the hydrocarbon stream 102 entering the EKS, where p1 and p2 can be, independently: 1,000; 2,000; 3,000; 4,000; 5,000; 6,000; 7,000; 8,000; 9,000; 10,000; 12,000; 14,000; 15,000; 16,000; 18,000; 20,000; 22,000; 24,000; 25,000; 26,000; 28,000; 30,000; as long as p1<p2. In some embodiments, as discussed in more detail below, the solid particles may include a filtration aid, such as diatomaceous earth.

The hydrocarbon stream 102 may be introduced into the system 100 via an inlet conduit 106. In some embodiments, the hydrocarbon stream 102 may be conveyed directly into the EKS 104 for salt and solid particle removal, and the EKS 104 may discharge a purified product stream 108 into an outlet conduit 110. Electro-kinetic separation is performed by applying a direct current (DC) or alternating current (AC) voltage to electrodes that are separated by a dielectric medium, and thus creating an electric field. The hydrocarbon stream 102 flows through the resulting electric field and, based on Coulomb's Law, solid particles bearing an electrical charge or polarized electric charge distribution will tend to move in desirable directions in the electric field, attach to a dielectric medium of the EKS 104, and become immobilized. The net result is the product stream 108 exiting the EKS 104 with abated salt and solid particle count.

In other embodiments, however, the system 100 may further and optionally include one or both of a separation device 112 and a heat exchanger 114. In such embodiments, the hydrocarbon stream 102 may optionally be circulated through one or both of the separation device 112 and the heat exchanger 114 prior to being introduced into the EKS 104. However, one or both of the separation device 112 and the heat exchanger 114 may follow or otherwise be arranged after the EKS 104, without departing from the scope of the disclosure. Moreover, while only one separation device 112 and one heat exchanger 114 are depicted in the system 100, the system 100 may incorporate a plurality of separation devices 112 and/or a plurality of heat exchangers 114, without departing from the scope of the disclosure. In such embodiments, the system 100 may include one or more separation devices 112 and/or heat exchangers 114 arranged prior to and/or after the EKS 104, without departing from the scope of the disclosure.

The separation device 112 may comprise any conventional system or process configured to generally separate salts and/or solid particles from a fluid (e.g., the hydrocarbon stream 102) and discharge a process stream 116. In at least one embodiment, the separation device 112 may comprise a conventional desalter or “settler” that uses a high voltage electrostatic field to separate the hydrocarbon stream 102 into an oil phase and a water phase and in the process remove salts and solid particles from the oil phase. In other embodiments, however, the separation device 112 may comprise a water washing device or the like that helps remove salts and solid particles.

In yet other embodiments, or in addition thereto, the separation device 112 may comprise a mechanical filter comprising a filtration system that separates solid matter from a solid/fluid mixture effected only through traditional mechanical forces resulting from gravity, centrifugation, pressure gradient (vacuum or positive pressure), or any combination thereof, without intentionally exerting an external force to the solid matter to be separated from a liquid by an electric field. A rotary drum filter assisted with a vacuum, for example, is a widely used mechanical filtration device for separating solids from liquids. In such embodiments, the hydrocarbon stream 102 may be circulated through a porous membrane with pores small enough to exclude a portion of the solid particles. The porous membrane filter may require a filtration aid, typically in the form of diatomaceous earth, which forms a layer on the membrane filter to help collect solids that would otherwise bypass or clog the filter.

In embodiments including the heat exchanger 114, the process stream 116 discharged from the separation device 112 may optionally be circulated through the heat exchanger 114 prior to being introduced into the EKS 104. Alternatively, the separation device 112 may be omitted and the hydrocarbon stream 102 may be conveyed directly to the heat exchanger 114, without departing from the scope of the disclosure. In yet other embodiments, the heat exchanger 114 may precede the separation device 112 in the system 100.

The heat exchanger 114 may be designed to adjust the temperature of the process stream 116 (or the hydrocarbon stream 102) to a desirable level and discharge a temperature-adjusted process stream 118. The heat exchanger 114 may be configured to discharge the temperature-adjusted process stream 118 at a temperature ranging from T1 (° F.) to T2 (° F.), where T1 and T2 can be, independently, 300, 290, 280, 270, 260, 250, 240, 230, 220, 210, 200, 190, 180, 170, 160, 150, 140, 130, 120, 110, 100, 90, 80, 70, 60, or even 50, as long as T1<T2. In at least one embodiment, the heat exchanger 114 may be configured to reduce the temperature of the process stream 116 to a desirable level. In other embodiments, the heat exchanger 114 may be configured to adjust the temperature of the process stream 116 to above ambient temperature, such as about 25° C. (77° F.). The temperature-adjusted process stream 118 may then be conveyed to the EKS 104 for further processing.

In at least one embodiment, the temperature-adjusted process stream 118 may include a filtration aid for the purpose of conglomerating very fine solid particles contained therein, much similar to the filtration aids used in processes using only conventional mechanical filtration. The filtration aid may comprise, for example, diatomaceous earth. The EKS 104 may be configured to capture very fine particles that may have bypassed the filtration and separation capabilities of the preceding separation device(s) 112. While in certain situations it may be desirable to use a special filtration aid to facilitate solid particle abatement through the EKS 104, the EKS 104 may nevertheless be configured to reduce the quantity of filtration aid required as compared to conventional particle abatement processes that do not incorporate electro-kinetic separation. Accordingly, as mentioned above, it is contemplated herein to use the EKS 104 for solid particle abatement only, thus wholly or partially eliminating the need of the separation device 112.

FIG. 2A is a schematic diagram of one example of the EKS 104, according to one or more embodiments. It is noted that the EKS 104 is depicted merely as an illustrative embodiments and, thus, should not be considered limiting to the scope of the present disclosure. Indeed, various alternative designs or modifications to the EKS 104 may be incorporated, without departing from the scope of the disclosure.

As illustrated, the EKS 104 may include a cylindrical body 202 (alternately referred to a “cleaning chamber”) having a first end 204a and a second end 204b opposite the first end 204a. The first end 204a may comprise an input end designed to receive a process stream 205, and the second end 204b may comprise an output end that discharges the purified product stream 108. The process stream 205 may comprise the hydrocarbon stream 102 (FIG. 1) and/or the temperature-adjusted process stream 118 (FIG. 1). While not shown, the first and second ends 204a,b may be generally sealed and capable of receiving the process stream 205 and discharging the product stream 108.

The EKS 104 comprises at least two electrodes made of electrically conductive materials and, therefore, capable of conducting electricity at the operating conditions. In the illustrated embodiment, the electrodes comprise first and second electrodes 206a and 206b in the form of concentric outer and inner cylinders with opposite polarity. In other embodiment, however, the electrodes 206a,b may take on other forms or geometric shapes capable of generating an electric field, without departing from the scope of the disclosure. Suitable electrically conductive materials that may be used for the electrodes 206a,b include, but are not limited to, carbon, silicon, a metal (e.g., steel, aluminum, copper, silver, gold, other precious metals, etc.), a metal alloy, a conductive ceramic, or any combination thereof.

The EKS 104 may comprise EKS media 208 (i.e., a dielectric medium) interposing the electrodes 206a,b. While the process stream 205 can directly contact the electrodes 206a,b applying the electric field, it is contemplated to position the EKS media 208 as a dielectric barrier between the electrodes 206a,b and the process stream 205. This may be especially advantageous if a high voltage is applied between the electrodes 206a,b, and/or the process stream 205 has a high conductivity, which can result in large currents if direct contact between the process stream 205 and the electrodes 206a,b is allowed.

Suitable EKS media 208 that may be used in the EKS 104 include any solid material that has a low electrical conductivity under the operating conditions of the EKS 104. In some embodiments, for example, the EKS media 208 may exhibit an electrical conductivity lower than the material used for the electrodes 206a,b. In at least one embodiment, the EKS media 208 has an electrical conductivity lower than the process stream 205 under the operating conditions. Non-limiting examples of suitable EKS media 208 include, but are not limited to, fibers, fibrous materials (e.g., glass wool, rock wool, synthetic plastic fibers, filamentary materials, etc.), a fabric to (e.g., non-woven or woven cellulose and the like), flakes, foams (e.g., polyurethane foam, an open-foam material), a mesh, pellets or beads (e.g., made of materials such as glass, ceramic, glass-ceramic, inorganic oxides, etc.), a cellulosic material (e.g., wood), or any combination thereof.

FIG. 2B is a partial cross-sectional end view of one example of the EKS media 208 of FIG. 2A, according to one or more embodiments. As illustrated, the EKS media 208 may comprise a cartridge 210 radially disposed between the electrodes 206a,b and including three layers 212a, 212b, 212c of a pleated fabric material (e.g., a non-woven cellulosic pleated material). The cartridge 210 is bounded on inner and outer surfaces with the electrodes 206a,b and each layer 212a,b may be separated longitudinally by corresponding dielectric dividers 214. The dielectric dividers 214 may be made of any dielectric material mentioned herein. In at least one embodiment, the dielectric dividers 214 may be made of cotton.

The pleated material of each layer 212a-c may form distinct, longitudinally extending channels 216 that extend generally between the first and second ends 204a,b (FIG. 2A) of the EKS 104 (FIG. 2A). The channels 216 form individual flow passageways through which the process stream 205 may flow between the first and second ends 204a,b. In some embodiments, as illustrated, the channels 216 may comprise triangular-shaped channels, but may otherwise form any suitable geometry through which the process stream 205 may flow.

Referring jointly to FIGS. 2A-2B, during example operation of the EKS 104, a voltage (DC or AC) is applied to the electrodes 206a,b, which generates an electric field that extends through the EKS media 208. The process stream 205 is circulated through the electric field and salts and solid particles bearing electrical charges are forced to travel in the electric field as a result of Coulomb forces exerted thereto. Neutral solid particles can also be induced to become electrically polarized in the electric field, and then move in certain directions as a result of Coulomb forces.

The EKS media 208 and the process stream 205 have different permittivities, which according to Laplace's equation, alters the electric field and results in regions of high field gradient near the corners of the cartridge 210. The non-uniformity in the electric field is the driving force for dielectrophoresis, thus the geometry of the cartridge 210 may be critical to the separation performance. Consequently, the material of the EKS media 208 (e.g., each layer 212a-c of the cartridge 210) may be configured to collect solid particles when the electric field is applied between the electrodes 206a,b. More specifically, as the process stream flows through the channels 216 and the electric field, solid particles may be attracted to the fabric, adhere to the fabric, and collected on the fabric, without being carried to the downstream equipment, to achieve the particle abatement to effect.

The amplitude of the voltage applied and the characteristics of the voltage profile (e.g., constant DC or AC, alternating sinusoid, alternating flat pulses, or other profiles), the type of electrode material, shape, dimension, and position of the electrodes 206a,b, as well as the distance between the electrodes 206a,b, can be chosen by one skilled in the art to meet the need of the specific application, flow rate of the feed stream, operating temperature, particle concentration in the feed stream, number of EKSs used, particle concentration required for the stream passed on to the downstream equipment, recycle ratio, and the like.

In some embodiments, the process stream 205 may be a poor electrical conductor under the operating conditions. Thus, any electric current flowing through the process stream 205 during operation of the EKS 104 may be negligible, and upstream and downstream equipment may not be electrified to an unsafe level through the process stream 205 in direct contact with the electrodes 206a,b.

The EKS 104 may be operated at a pressure of about 100 kPaa (kilopascal absolute pressure) to about 3500 kPaa or about 100 kPaa to about 3000 kPaa, or about 100 kPaa to about 2500 kPaa, or about 100 kPaa to about 2000 kPaa, or about 100 kPaa to about 1500 kPaa, or about 100 kPaa to about 1000 kPaa, or about 100 kPaa to about 500 kPaa, or about 250 kPaa to about 3500 kPaa, or about 250 kPaa to about 3000 kPaa, or about 250 kPaa to about 2500 kPaa, or about 250 kPaa to about 2000 kPaa, or about 250 kPaa to about 1500 kPaa, or about 250 kPaa to about 1000 kPaa, or about 250 kPaa to about 500 kPaa, or about 500 kPaa to about 3500 kPaa, or about 500 kPaa to about 3000 kPaa, or about 500 kPaa to about 2500 kPaa, or about 500 kPaa to about 2000 kPaa, or about 500 kPaa to about 1500 kPaa, or about 500 kPaa to about 1000 kPaa.

The product stream 108 exiting the EKS 104 has a reduced content of solid particles as compared to the process stream 205 entering the EKS 104. In various aspects, the product stream 108 may comprise solid particles in a concentration, as measured by ASTM D4807-05, of less than about 10,000 ppmw (parts per million by weight), less than about 7,500 ppmw, less than about 5,000 ppmw, less than about 2,500 ppmw, less than about 1,000 ppmw, less than about 750 ppmw, less than about 500 ppmw, less than about 250 ppmw, less than about 100 ppmw, less than about 75 ppmw, less than about 50 ppmw, less than about 25 ppmw, less than about 10 ppmw, less than about 1.0 ppmw, or less than about 0.50 ppmw or about 0.010 ppmw, based on the total weight of the process fluid exiting the EKS. Additionally or alternatively, the product stream 108 may comprise solid particles in a concentration of about 0.010 ppmw to about 10,000 ppmw, about 0.010 ppmw to about 5,000 ppmw, about 0.010 ppmw to about 1,000 ppmw, about 0.010 ppmw to about 100 ppmw, about 0.010 ppmw to about 50 ppmw, about 0.010 ppmw to about 10 ppmw, or about 0.010 ppmw to about 1.0 ppmw.

The EKS 104 can be advantageously used for process streams containing solid particles that have small sizes, such as those having an average particle size of at most 1000 micrometer (μm), such as at most: 700 μm, 600 μm, 500 μm, 400 μm, 300 μm, 200 μm, 100 μm, 80 μm, 60 μm, 50 μm, 40 μm, 20 μm, 10 μm, 9 μm, 8 μm, 6 μm, 5 μm, 4 μm, 3 μm, or 5 μm.

As the process stream 205 flows through the EKS 104, the EKS media 208 may reach a desired level of captured solid particles, such as any convenient amount up to the maximum capacity of the EKS media 208 for capturing and retaining solids. This desired capacity of the EKS 104 can be determined by many factors, including but not limited to the voltage profile applied to the electrodes 206a,b, flow rate of the process stream 205, solid particle density and particle size distribution in the process stream 205, the type and capacity of the EKS media 208 used for collecting solid particles, and the like.

When the EKS media 208 reaches its particle collection capacity, it may be desirable to regenerate the EKS media 208 to remove at least a portion of the collected solid particles from the EKS media 208, thereby reclaiming or restoring at least part of the capacity. One contemplated regeneration process includes removing the soiled EKS media 208 from the EKS device 104, cleaning the EKS media 208 using mechanical means, chemical means, electrical means, or any combination thereof, and re-installing the cleaned EKS media 208 into the EKS 104. Solvents, detergents, flames, oxidizing agents, plasma, brushes, stirring devices, flushing fluid streams, and the like, may be used for cleaning the soiled EKS media 208.

In at least one embodiment, however, an in-situ regeneration process may be used. In such embodiments, the EKS media 208 may be allowed to remain in the EKS 104 during regeneration. During such in-situ regeneration process, the supply of the process stream 205 to the EKS 104 may be turned off partly or completely, and voltage applied to the electrodes 206a,b may be reduced to zero or changed to a profile favorable for releasing captured solid particles so that they may be flushed out of the EKS 104. During in-situ regeneration of the EKS media 208, a process compatible fluid, such as a backwash fluid, may be passed through the EKS 104, whereby at least a portion of the solid particles collected in the EKS media 208 is flushed out. The process compatible fluid may be any suitable fluid (including liquids, gases and mixtures thereof), including but not limited to: air, nitrogen, a hydrocarbon (e.g., methane, ethane, butane, hexane, cyclohexane, kerosene, naphtha, diesel fuel, etc.), a solvent, or an aqueous liquid. In at least one embodiment, the process-compatible washing fluid may be miscible with the process stream 205.

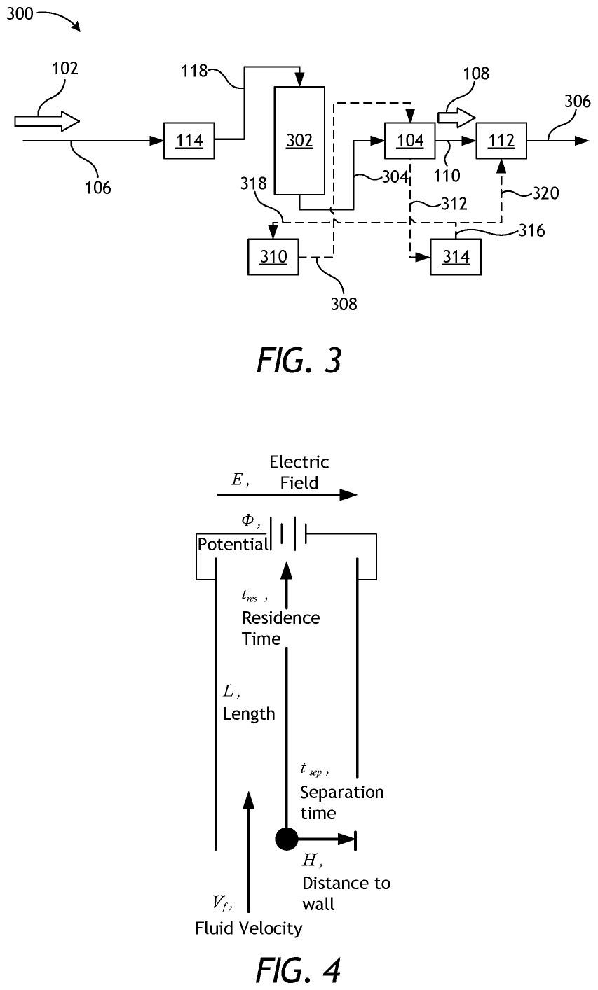

FIG. 3 is a schematic diagram of another system 300 for removing salt and solid particles from the hydrocarbon stream 102 and further including cleaning and regeneration capabilities, according to one or more embodiments. The system 300 may be similar in some respects to the system 100 of FIG. 1 and therefore may be best understood with reference thereto, where like numerals will correspond to like components not described again in detail. The system 300 can be operated in cleaning mode where a process stream passes through the EKS 104 to be cleaned, or alternatively, in regeneration mode where a cleaning/washing fluid is conveyed through the EKS 104 to remove at least a portion of the solid particles collected and accumulated inside the EKS 104 and thereby reclaim at least a portion of the particle abatement capacity thereof.

As illustrated, the hydrocarbon stream 102 may be conveyed into the system 300 via the inlet conduit 106 and may have salts and solid particles entrained therein. To abate the solid particles contained therein, hydrocarbon stream 102 may be temperature-adjusted to a suitable temperature by the heat exchanger 114 to obtain the temperature-adjusted process stream 118. In some embodiments, an optional EKS feed tank 302 may be used for storing the temperature-adjusted process stream 118 and supplying a process stream 304 at suitable temperature to the EKS 104.

During cleaning mode, the process stream 304 is supplied to the EKS 104 where at least a portion of the solid particles are adsorbed by the EKS media 208 (FIGS. 2A-2B) and the product stream 108 is discharged into the outlet conduit 110 with an abated quantity of solid particles. In at least one embodiment, the product stream 108 may subsequently pass through the separation device 112 to obtain a further treated product stream 306 comprising solid particles at a further reduced concentration therein compared to the product stream 108. The product stream 306 may then be conveyed downstream to other processing equipment.

During in-situ regeneration, the process stream 304 to the EKS 104 may be turned off, and a process-compatible backwash fluid stream 308 (e.g., air, nitrogen, a hydrocarbon, a solvent, an aqueous liquid, etc.) supplied from a process-compatible backwash fluid supply tank 310 may be introduced to the EKS 104. The backwash fluid stream 308 may be configured to flush out of the EKS 104 at least a portion of the solid particles collected in the EKS media 208 (FIGS. 2A-2B). In some embodiments, at least 50 wt %, 60 wt %, 70 wt %, 80 wt %, or 90 wt %) may be flushed out of the EKS 104 with the backwash fluid stream 308, and a solid particle-laden process-compatible backwash fluid stream 312 (shown in dashed line) may be produced.

In at least one embodiment, the stream 312 may be introduced into a settling tank 314 (or another solid-liquid separation device) where the solid particles may settle to the bottom. After separation, a fluid stream 316 (in dashed line) containing solid particles at a concentration lower than the stream 312 may be obtained, which may be partly or completely recycled back to the process-compatible backwash fluid tank 310 as stream 318. In some embodiments, the separation device 112 may make use of a washing fluid stream to wash the filter cake to remove residual liquid entrained in the filter cake. In such embodiments, additionally or alternatively, at least a portion of the stream 316, shown as stream 320 may be supplied to the separation device 112 as at least a portion of the washing fluid for removing residual liquid entrained in the filter cake.

Additionally or alternatively, instead of regenerating the EKS media 208 (FIGS. 2A-2B), the EKS media 208 may be replaced once the EKS media 208 reaches a desired level of captured solid particles as described herein. For example, the EKS media 208 may be replaced after one separation cycle, two separation cycles, three separation cycles, four separation cycles, or five separation cycles. For example, a first separation cycle can comprise passing a designated process stream volume through the EKS 104 to produce the product stream 108 and a second cycle can comprise passing at least a portion of the product stream 108 back through the EKS 104, and so on. Alternatively, a first separation cycle can comprise passing a first designated process stream volume through the EKS 104 to produce a first product stream 108 and a second cycle can comprise passing a second designated process stream volume through the EKS 104 to produce a second product stream 108. In at least one embodiment, however, a continuous fresh feed stream supplied from the equipment upstream from the EKS 104 may be passed through the EKS 104 to obtain a solid particulate abated stream, which is then split into at least two streams, one of which is recycled to the EKS 104, and the other to the downstream equipment, which can be a downstream EKS, a distillation column, a storage unit, or other vessels.

The ratio of the weight of the stream recycled to the EKS 104 to the weight of the process stream 304 entering the EKS 104 can vary significantly, depending on the particle concentration in the fresh feed stream entering the EKS 104, the efficiency and capacity of the EKS 104, and the desired particle concentration in the stream allowed to leave to the downstream equipment. In at least one embodiment, the recycle ratio can range from r1 to r2, where r1 and r2 can be, independently, 0.1, 0.2, 0.3, 0.4, 0.5, 0.6, 0.7, 0.8, 0.9, 1, 2, 3, 4, 5, 6, 7, 8, 9, 10, 20, 30, 40, 50, 60, 70, 80, 90, 100, as long as r1<r2. At a given capacity and efficiency of the EKS 104, and all other process conditions held equal, the higher the recycle ratio, the lower the concentration of solid particles in the stream passed on to the downstream equipment will be.

It is noted that the EKS 104 is described herein as a single unit. It is contemplated herein, however, to employ a plurality of electro-kinetic separators, which may be connected in parallel or in series to meet the solid particle abatement performance requirements of the process. In at least one embodiment, at least two of the multiple electro-kinetic separators may be configured such that they are capable of being operated in parallel, i.e., both receiving a fresh feed stream from the same upstream equipment. A system having the capability of operating multiple electro-kinetic separator units in parallel permits the possibility of operating one electro-kinetic separator in cleaning mode (i.e., a mode where fresh feed stream is accepted and a treated product stream is produced) and operating the other electro-kinetic separator in regeneration mode or idling mode if needed, thus allowing for a steady and uninterrupted operation of the whole product manufacture system.

### Examples

Crude oil feed and crude oil processed through an electro-kinetic separator similar to the EKS 104 described herein were analyzed both for salt content via ASTM D3230 and fines (solid particle) concentration via ASTM D4807-05 using a 0.45 μm filter/hot toluene wash. Results of four experiments using different crude oils are presented in Table 1 below:

TABLE 1

| | | Salt | Salt | Feed | Product |
|---|---|---|---|---|---|
| Example | Hydrocarbon | (ptb) | (ptb) | Solids | Solids |
| # | Stream | Feed | Product | (ppm) | (ppm) |
| 1 | Crude 1 | 10.6 | 2.4 | 300 | 150 |
| 2 | Crude 1 + NaCl | 306.7 | 1.9 | 1150 | 270 |
| | (brine) | | | | |
| 3 | Crude 1 + Crude 2 | 18.3 | 5.6 | 860 | 100 |
| 4 | Crude 3 | 6.2 | 0.7 | 420 | 80 |

The salt product and the product solids in Crudes 1-3 were measured after being processed in an electro-kinetic separator similar to the EKS 104. Example 1 shows that the salt concentration in Crude 1 was reduced from 10.6 pounds per thousand barrels (ptb) to 2.4 ptb and the total solid fines concentration was reduced from 300 parts per million (ppm) to 150 ppm.

In Example 2, Crude 1 was spiked with an aqueous NaCl solution (25% by weight NaCl dissolved in water). More specifically, 100 μm of the NaCl solution was added to 1.5 gallons of Crude 1 and mixed vigorously following which the mixture phase was allowed to separate. The hydrocarbon phase was separated and processed through an electro-kinetic separator similar to the EKS 104. As shown in Table 1, salt concentration was reduced from about 307 ptb to 1.9 ptb, and the solid fines concentration was reduced from 1150 ppm to 270 ppm.

In Example 3, Crude 1 was spiked with a separate, high-salt Crude 2 to again increase the salt and particle content of the hydrocarbon stream processed through the electro-kinetic separator. More specifically, about 1 liter of high-salt Crude 2 was mixed with 1.5 gallons of Crude 1. The mixture had a salt concentration of 18.3 ptb, which when processed in the electro-kinetic separator was reduced to 5.6 ptb. Solid fines concentration reduced from 860 ppm to 80 ppm.

In Example 4, a different crude, Crude 3, without any spiking, was tested in an electro-kinetic separator similar to the EKS 104. The electro-kinetic separator unit reduced the salt concentration from 6.2 ptb to 0.7 ptb and solid fines concentration was reduced from 170 ppm to 80 ppm.

The foregoing examples show that electro-kinetic separation can reduce salt content as well as other solid fines concentration in crude samples. The extent of removal, however, is a function of various variables such as electrical field strength and configuration (and also material) of fines capturing media. It is contemplated that by varying certain operating variables, the removal efficiency of salt and fines can be improved.

### Predictive Modeling of Fines Separation

A fundamental model was developed to predict fines removal from hydrocarbon streams. The model predicts the per-pass separation efficiency for an electro-kinetic separator similar to the EKS 104 based on device geometry and physical and electrical properties of the fines and hydrocarbon. The predicted fines concentration matches well to experimental data for clay-bitumen and fines-crude systems. The model may be used to select operating conditions for maximum fines separations.

### Mathematical Model

The model developed for this system is based on a comparison of relevant timescales: the residence timescale for a particle based on the superficial fluid velocity, V_{f}, and the separation timescale, based on the dielectrophoretic particle velocity. Here, electrophoresis is assumed negligible due to a presumed minimal particle surface charge in a hydrocarbon fluid. A schematic of the linear channels is shown in FIG. 4, which is a schematic of particle motion in a linear channel under the influence of an electric field.

The residence timescale, tᵣₑₛ, can be written as:

$${t}_{res} = \frac{L}{{V}_{f}}$$

where L is the length of the channel. The separation timescale, tₛₑₚ, is:

$${t}_{sep} = \frac{H}{{V}_{p}} = \frac{3 η H}{{ɛ}_{m} {R}^{2} Re ( {\tilde{f}}_{CM} ) ∇ \vert {E}^{2} \vert} ,$$

where η is the fluid viscosity, H is the distance from the center of the channel to the wall, εₘ is the fluid permittivity, R is the particle radius, and E is the electric field. Re(f̅ₘ) is the Clausius-Mossotti factor describing the difference between the particle and fluid complex permittivities. In a DC field, this simplifies to:

$$Re ( {\tilde{f}}_{CM} ) = \frac{{σ}_{p} - {σ}_{m}}{{σ}_{p} + 2 {σ}_{m}} .$$

The difference between the conductivity of the particle, σₚ, and the fluid permittivity, σₘ, is crucial to the separation efficiency. These timescales can be combined into a dimensionless separation number, F,

$$Γ = \frac{{t}_{res}}{{t}_{sep}} = \frac{{ɛ}_{m} {R}^{2} LRe ( {\tilde{f}}_{CM} ) ∇ \vert {E}^{2} \vert}{3 η {V}_{f} H}$$

When Γ>1, the separation timescale is shorter than the residence timescale, indicating that separation is possible. When Γ<1, there is minimal separation of particles from the bulk fluid. This construct is a useful check to predict whether or not a fines-hydrocarbon system is a candidate for electro-kinetic separation. However, this does not give any information on the percentage of particles removed. To add in this capability, we switch from a dimensionless group based on average parameters to a spatially-dependent γ(x,y).

### Spatially-Dependent Separation Number

The separation number includes several parameters that are readily re-envisioned as spatially-dependent variables. This includes h(x,y), the distance from a particle to the nearest wall, the fluid velocity profile v_{z}, and the gradient of the electric field squared, V̅(x,y)²|. For an isosceles triangular channel of angle θ, the distance to the nearest triangle wall can be described as:

$$h ( x , y ) = {min}_{Δ} \{ y - H , y tan \frac{θ}{2} - \vert x \vert \}$$

The velocity profile for laminar flow in a triangular channel is given by:

$${v}_{z} ( x , y ) = \frac{15 {V}_{f}}{{H}^{3}} ( y - H ) ( {x}^{2} {cot}^{2} \frac{θ}{2} - {y}^{2} )$$

The electric field can be calculated from the potential, e(x,y)=−∇φ, and the differential form of Gauss' law:

∇·(ε∇φ)=0

The boundary conditions for the potential are defined at the four edges of the bounding box, which includes three cartridge pleats sandwiched between the electrode and a cotton spacer (e.g., the dielectric divider 214 of FIG. 2B). They are written as a single piecewise continuous function of y as follows:

$${ϕ}_{0} ( y ) = \{ \begin{matrix}\frac{V {ɛ}_{m} y}{H {ɛ}_{c} + 2 δ ( {ɛ}_{m} - {ɛ}_{c} )} , & 0 \leq y < δ \\ \frac{V ( {ɛ}_{c} y + δ ( {ɛ}_{m} - {ɛ}_{c} ) )}{H {ɛ}_{c} + 2 δ ( {ɛ}_{m} - {ɛ}_{c} )} , & δ \leq y < H - δ \\ V + \frac{V {ɛ}_{m} ( y - H )}{H {ɛ}_{c} + 2 δ ( {ɛ}_{m} - {ɛ}_{c} )} , & H - δ \leq y \leq H\end{matrix}$$

At each of the boundaries of the bounding rectangle, the potential φ=φ₀. The non-uniformity in the electric field arises because the permittivity ε of the cartridge is different from that of the fluid. To account for differing permittivity in various regions, we solve Gauss' law via finite elements method.

The electric field is calculated from e(x,y)=−∇φ. To insert the electric field into the separation number, ∇|e(x,y)²| is needed. This gradient is a vector containing both an x and y component. To simplify the model, instead use the magnitude of this quantity, |∇|e(x,y)²∥.

The separation number

$$γ ( x , y ) = \frac{{ɛ}_{m} {R}^{2} LRe ( {\tilde{f}}_{CM} ) \vert ∇ \vert {e ( x , y )}^{2} \vert \vert}{3 η {v}_{z} ( x , y ) h ( x , y )}$$

is calculated at each node point.

### Fraction of Particles Removed

In a single pass through the cartridge, a fraction of particles is removed. To predict this, it is first assumed that the particles are uniformly distributed in the triangular channel in x and y at the start of the channel, z=0. With this assumption, the fraction of the area of the triangle where the separation number γ>1 is equal to the fraction of particles removed in a single pass.

This area fraction is then equal to the fraction of particles removed per pass through the cartridge, χ

$$χ = 1 - \frac{Area , γ < 1}{Δ Area}$$

In a typical lab-scale experiment, fluid passes through the cleaning chamber (e.g., the electro-kinetic separator) and a holding tank a large number of times. The concentration of particles as a function of passes through the cartridge, n, is given by:

C(n)=(C₀−Cₙ)(1−χ)ⁿ+Cₙ

where C₀ is the initial concentration of fines and Cₙ is a fitting parameter for the final concentration after the system reaches steady state and no additional particles are removed. The power-law nature of the particle removal is significant because it highlights the importance of increasing the number of passes. Fundamentally, n represents the number of times the particles are mixed resulting in a uniform particle inlet distribution. This expression indicates that to increase per pass removal, it is vital to introduce mixing in the linear channels.

Comparison with Experiments

Typical experiments involve running a feed in the electro-kinetic separator continuously and samples are drawn periodically throughout the run. To determine the concentration of particulates, the samples are filtered, and then the number of particles on the filter paper is measured. This results in a concentration with units ppm of particles larger than the filter size.

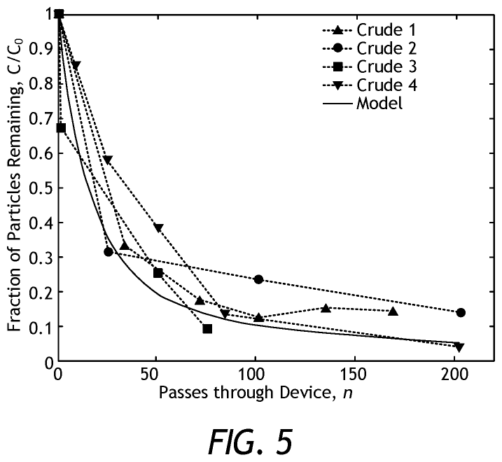

FIG. 5 is a plot depicting concentrations of four crudes compared against the predictive model. More specifically, FIG. 5 depicts solids concentration C for Crude 1, Crude 2, Crude 3, and Crude 4 compared to predicted concentration (the Model) and against the number of passes through the device, n. The number of passes was calculated based on the liquid flow rate and device dimensions. As can be seen in FIG. 5, the model agrees quite well with experimental data. The only fitting parameter here is the final concentration at steady state, G. This model can now be used to improve experimental and device design in a predictive manner.

### EMBODIMENTS DISCLOSED HEREIN INCLUDE

A. A method that includes introducing a crude oil process stream into an electro-kinetic separator (EKS), passing the crude oil process stream through an electric field generated by the EKS, removing at least a portion of salt and solid particles from the crude oil process stream as the crude oil process stream passes through the electric field, and discharging a product stream from the EKS with reduced salt and solid particle count as compared to the crude oil process stream.

B. A process for treating a hydrocarbon stream comprising salt and solid particles that includes conveying the hydrocarbon stream through at least one of a separation device and a heat exchanger, and thereby generating a process stream, introducing the process stream into an electro-kinetic separator (EKS), passing the process stream through an electric field generated by the EKS, removing at least a portion of the salt and the solid particles from the process stream as the process stream passes through the electric field, and discharging a product stream from the EKS with reduced salt and solid particle count as compared to the hydrocarbon stream.

Each of embodiments A and B may have one or more of the following additional elements in any combination: Element 1: wherein the solid particles are selected from the group consisting of sand, proppant, rock, salt, a corrosion product, and any combination thereof. Element 2: wherein the solid particles have an average particle size in the range from 1 to 1000 micrometers. Element 3: wherein the solid particles have an average particle size in the range from sub-micron to about 25 micrometers. Element 4: further comprising conveying the crude oil process stream through a separation device prior to entering the EKS, wherein the separation device is selected from the group consisting of a desalter, a water washing device, a mechanical filter, and any combination thereof. Element 5: further comprising conveying the crude oil process stream through a heat exchanger prior to entering the EKS. Element 6: further comprising adjusting a temperature of the crude oil process stream to at least ambient temperature in the heat exchanger. Element 7: wherein the EKS comprises at least two electrodes and an EKS media disposed between the at least two electrodes, the method further comprising generating the electric field by applying a direct current or alternating current voltage between the at least two electrodes, flowing the crude oil process stream through the EKS media and the electric field, and attaching the portion of the salt and the solid particles from the crude oil process stream to the EKS media, wherein the EKS media is made of a dielectric material selected from the group consisting of fibers, a fibrous material, a fabric, flakes, a foam, a mesh, pellets or beads, and any combination thereof. Element 8: wherein the EKS media comprises a cartridge radially disposed between the at least two electrodes and including one or more layers of a pleated fabric material defining a plurality of longitudinally extending channels, wherein flowing the crude oil process stream through the EKS media comprises flowing the crude oil process stream through the plurality of longitudinally extending channels. Element 9: wherein the EKS media is made of a material selected from the group consisting of an inorganic glass, a ceramic, a glass ceramics, an inorganic oxide, a cellulosic material, and any combination thereof. Element 10: further comprising regenerating the EKS media. Element 11: wherein regenerating the EKS media comprises removing the EKS media from the EKS, cleaning the EKS media using at least one of mechanical means, chemical means, electrical means, and any combination thereof, and replacing the EKS media into the EKS for further operation. Element 12: wherein regenerating the EKS media comprises circulating a process compatible fluid through the EKS media to remove at least a portion of the solid particles collected in the EKS media. Element 13: wherein the process-compatible washing fluid is selected from the group consisting of air, nitrogen, a hydrocarbon, a solvent, an aqueous liquid, and any combination thereof.

Element 14: wherein the solid particles are selected from the group consisting of sand, proppant, rock, salt, a corrosion product, and any combination thereof. Element 15: wherein the separation device is selected from the group consisting of a desalter, a water washing device, a mechanical filter, and any combination thereof. Element 16: further comprising adjusting a temperature of the crude oil process stream to at least ambient temperature in the heat exchanger. Element 17: wherein the EKS comprises at least two electrodes and an EKS media disposed between the at least two electrodes, the method further comprising generating the electric field by to applying a direct current or alternating current voltage between the at least two electrodes, flowing the process stream through the EKS media and the electric field, and attaching the portion of the salt and the solid particles from the crude oil process stream to the EKS media, wherein the EKS media is made of a dielectric material selected from the group consisting of fibers, a fibrous material, a fabric, flakes, a foam, a mesh, pellets or beads, and any combination thereof. Element 18: further comprising regenerating the EKS media.

By way of non-limiting example, exemplary combinations applicable to A and B include: Element 5 with Element 6; Element 7 with Element 8; Element 7 with Element 9; Element 7 with Element 10; Element 10 with Element 11; Element 10 with Element 12; Element 12 with Element 13; and Element 17 with Element 18.

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

What is claimed is:

1. A method, comprising:
introducing a crude oil process stream into an electro-kinetic separator (EKS);
passing the crude oil process stream through an electric field generated by the EKS;
removing at least a portion of salt and solid particles from the crude oil process stream as the crude oil process stream passes through the electric field; and
discharging a product stream from the EKS with reduced salt and solid particle count as compared to the crude oil process stream.

2. The method of claim 1, wherein the solid particles are selected from the group consisting of sand, proppant, rock, salt, a corrosion product, and any combination thereof.

3. The method of claim 1, wherein the solid particles have an average particle size in the range from 1 to 1000 micrometers.

4. The method of claim 1, wherein the solid particles have an average particle size in the range from sub-micron to about 25 micrometers.

5. The method of claim 1, further comprising conveying the crude oil process stream through a separation device prior to entering the EKS, wherein the separation device is selected from the group consisting of a desalter, a water washing device, a mechanical filter, and any combination thereof.

6. The method of claim 1, further comprising conveying the crude oil process stream through a heat exchanger prior to entering the EKS.

7. The method of claim 6, further comprising adjusting a temperature of the crude oil process stream to at least ambient temperature in the heat exchanger.

8. The method of claim 1, wherein the EKS comprises at least two electrodes and an EKS media disposed between the at least two electrodes, the method further comprising:
generating the electric field by applying a direct current or alternating current voltage between the at least two electrodes;
flowing the crude oil process stream through the EKS media and the electric field; and
attaching the portion of the salt and the solid particles from the crude oil process stream to the EKS media, wherein the EKS media is made of a dielectric material selected from the group consisting of fibers, a fibrous material, a fabric, flakes, a foam, a mesh, pellets or beads, and any combination thereof.

9. The method of claim 8, wherein the EKS media comprises a cartridge radially disposed between the at least two electrodes and including one or more layers of a pleated fabric material defining a plurality of longitudinally extending channels, wherein flowing the crude oil process stream through the EKS media comprises flowing the crude oil process stream through the plurality of longitudinally extending channels.

10. The method of claim 8, wherein the EKS media is made of a material selected from the group consisting of an inorganic glass, a ceramic, a glass ceramics, an inorganic oxide, a cellulosic material, and any combination thereof.

11. The method of claim 8, further comprising regenerating the EKS media.

12. The method of claim 11, wherein regenerating the EKS media comprises:
removing the EKS media from the EKS;
cleaning the EKS media using at least one of mechanical means, chemical means, electrical means, and any combination thereof; and
replacing the EKS media into the EKS for further operation.

13. The method of claim 11, wherein regenerating the EKS media comprises circulating a process compatible fluid through the EKS media to remove at least a portion of the solid particles collected in the EKS media.

14. The method of claim 13, wherein the process-compatible washing fluid is selected from the group consisting of air, nitrogen, a hydrocarbon, a solvent, an aqueous liquid, and any combination thereof.

15. A process for treating a hydrocarbon stream comprising salt and solid particles, comprising:
conveying the hydrocarbon stream through at least one of a separation device and a heat exchanger, and thereby generating a process stream;
introducing the process stream into an electro-kinetic separator (EKS);
passing the process stream through an electric field generated by the EKS;
removing at least a portion of the salt and the solid particles from the process stream as the process stream passes through the electric field; and
discharging a product stream from the EKS with reduced salt and solid particle count as compared to the hydrocarbon stream.

16. The process of claim 15, wherein the solid particles are selected from the group consisting of sand, proppant, rock, salt, a corrosion product, and any combination thereof.

17. The process of claim 15, wherein the separation device is selected from the group consisting of a desalter, a water washing device, a mechanical filter, and any combination thereof.

18. The method of claim 15, further comprising adjusting a temperature of the crude oil process stream to at least ambient temperature in the heat exchanger.

19. The process of claim 15, wherein the EKS comprises at least two electrodes and an EKS media disposed between the at least two electrodes, the method further comprising:
generating the electric field by applying a direct current or alternating current voltage between the at least two electrodes;
flowing the process stream through the EKS media and the electric field; and
attaching the portion of the salt and the solid particles from the crude oil process stream to the EKS media, wherein the EKS media is made of a dielectric material selected from the group consisting of fibers, a fibrous material, a fabric, flakes, a foam, a mesh, pellets or beads, and any combination thereof.

20. The process of claim 19, further comprising regenerating the EKS media.
